(19) United States
(12) Patent Application Publication
(10) Pub. No.: US 2020/0274897 A1
(43) Pub. Date: Aug. 27, 2020

(54) METHOD AND APPARATUS FOR PROCESSING DATA

(71) Applicant: Beijing Baidu Netcom Science And Technology Co., LTD., Beijing (CN)

(72) Inventors: Benjun Ye, Beijing (CN); Shaoyan Wang, Beijing (CN); Bing Huang, Beijing (CN)

(21) Appl. No.: 16/676,935

(22) Filed: Nov. 7, 2019

(30) Foreign Application Priority Data
Feb. 21, 2019 (CN) 201910129678.2

(51) Int. Cl. H04L 29/06; H04L 29/12

(52) U.S. Cl. CPC H04L 63/1458; H04L 63/10; H04L 61/3025; H04L 61/1511; H04L 61/6063; H04L 63/20

(57) ABSTRACT

Embodiments of the present disclosure relate to a method and apparatus for processing data. A method may include: receiving an access request to access a target domain name; converting the target domain name into a preset high defense domain name;

querying an IP corresponding to the high defense domain name in a domain name system; and sending the access request according to the IP corresponding to the high defense domain name; where in a case that an EIP corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

Embodiments of the present disclosure relate to the field of computer technology, specifically to a method and apparatus for processing data.

### BACKGROUND

At present, the total bandwidth of a cloud machine room is limited, resulting in a limited provision of EIP (Elastic IP) protection capability against DDoS (Distributed Denial of Service, referring to a large-scale collaborative denial-of-service attack enabled by a large number of controlled computers on the network) attacks. Once a user EIP of the cloud machine room is subjected to a large-scale DDoS attack, major operators may be called to black hole the attacked EIP, and all traffic accessing the EIP is blocked from entering the cloud machine room. The black hole lasts for one day. The black hole solves the impact of the DDoS attack on the entire cloud machine room network and guarantees the stability of most user services. However, for the user who uses the EIP, the service provided by the EIP is unavailable during the black hole.

To prevent the black hole from being triggered after the EIP is attacked and causing the service to be unavailable, the user may purchase a high defense IP and enjoy the capability of a higher protection against the attack to ensure that the service is available. However, DDoS attacks on user services do not occur frequently. Under normal circumstances, traffic accessing user services finally reaching the EIP through a high defense IP is not preferable in experience than directly accessing the EIP. The number of high defense IPs is limited, and the number of high defense IPs purchased by the same user is limited. When the user needs to purchase high defense services for a large number of EIPs, the needs cannot be satisfied.

### SUMMARY

Embodiments of the present disclosure provide a method and apparatus for processing data.

In a first aspect, an embodiment of the present disclosure provides a method for processing data, the method including: receiving an access request to access a target domain name; converting the target domain name into a preset high defense domain name; querying an IP corresponding to the high defense domain name in a domain name system; and sending the access request according to the IP corresponding to the high defense domain name; where in a case that an Elastic IP (EIP) corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

In some embodiments, before converting the target domain name into a preset high defense domain name, the method further includes: generating a high defense domain name; configuring the EIP corresponding to the target domain name, an area to which the EIP belongs, and health checking a port based on a Transmission Control Protocol (TCP) service; creating a record that the high defense domain name resolves to the EIP; and creating a record that the target domain name resolves to the high defense domain name.

In some embodiments, the method further includes: creating a high defense IP in response to detecting that the EIP is attacked and the black hole is enabled; creating a forwarding rule of returning from the high defense IP back to the EIP; and calling the domain name system to resolve the high defense domain name to switch to the high defense IP.

In some embodiments, the method further includes: calling the domain name system to resolve the high defense domain name to switch to the EIP, in response to detecting that the EIP ends the black hole.

In some embodiments, the method further includes: deleting the high defense IP and the forwarding rule; and recycling the high defense IP to an available pool.

In a second aspect, an embodiment of the present disclosure provides an apparatus for processing data, the apparatus including: a receiving unit, configured to receive an access request to access a target domain name; a conversion unit, configured to convert the target domain name into a preset high defense domain name; a querying unit, configured to query an IP corresponding to the high defense domain name in a domain name system; and a sending unit, configured to send the access request according to the IP corresponding to the high defense domain name; where in a case that an EIP corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

In some embodiments, the apparatus further includes a configuring unit, configured to: generate a high defense domain name before converting the target domain name into a preset high defense domain name; configure the EIP corresponding to the target domain name, an area to which the EIP belongs, and health check a port based on a Transmission Control Protocol (TCP) service; create a record that the high defense domain name resolves to the EIP; and create a record that the target domain name resolves to the high defense domain name.

In some embodiments, the apparatus further includes a scheduling unit, configured to: create a high defense IP in response to detecting that the EIP is attacked and the black hole is enabled; create a forwarding rule of returning from the high defense IP back to the EIP; and call the domain name system to resolve the high defense domain name to switch to the high defense IP.

In some embodiments, the scheduling unit is further configured to: call the domain name system to resolve the high defense domain name to switch to the EIP, in response to detecting that the EIP ends the black hole.

In some embodiments, the scheduling unit is further configured to: delete the high defense IP and the forwarding rule; and recycle the high defense IP to an available pool.

In a third aspect, an embodiment of the present disclosure provides an electronic device, including: one or more processors; and a storage apparatus, storing one or more programs thereon, the one or more programs, when executed by the one or more processors, cause the one or more processors to implement the method according to the first aspect.

In a fourth aspect, an embodiment of the present disclosure provides a computer readable medium, storing a computer program thereon, the program, when executed by a processor, implements the method according to the first aspect.

In the method and apparatus for processing data provided by the embodiments of the present disclosure, under normal circumstances, the traffic of a user accessing a domain name directly reaches the EIP. When the EIP is attacked and a black hole is triggered, the access traffic passes through a high defense IP and then to the EIP. When the EIP black hole is released, the access traffic is automatically switched back directly to the EIP. The whole process of the EIP triggering a black hole to releasing the black hole may be completely automated without the user's participation. This solution guarantees the availability of services when being attacked, and guarantees the best experience of user services under normal circumstances.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of an exemplary system architecture in which embodiments of the present disclosure may be implemented;

FIG. 2 is a flowchart of a method for processing data according to an embodiment of the present disclosure;

FIG. 3A and FIG. 3B are schematic diagrams of application scenarios of the method for processing data according to some embodiments of the present disclosure;

FIG. 4 is a flowchart of the method for processing data according to another embodiment of the present disclosure;

FIG. 5 is a schematic structural diagram of an apparatus for processing data according to an embodiment of the present disclosure; and

FIG. 6 is a schematic structural diagram of a computer system adapted to implement an electronic device of embodiments of the present disclosure.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

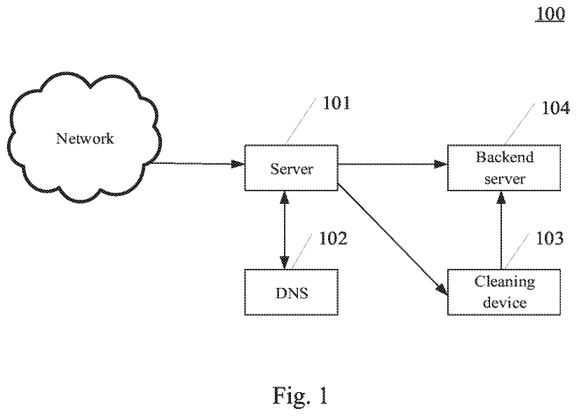

FIG. 1 illustrates an exemplary system architecture 100 of a method for processing data or an apparatus for processing data in which embodiments of the present disclosure may be implemented.

As shown in FIG. 1, the system architecture 100 may include a server 101, a DNS (Domain Name System) 102, a cleaning device 103, and a backend server 104. A network is used to provide a communication link medium between the server 101, the DNS 102, the cleaning device 103 and the backend server 104. The network may include various types of connections, such as wired, wireless communication links, or optic fibers.

The IP address of the cleaning device 103 is a high defense IP address, which is used to filter the data accessing the target domain name, and returns the filtered normal traffic to the source station IP. High defense IP is a paid value-added service launched for Internet servers in the condition that services are unavailable after suffering from a large traffic DDoS attack. The user may configure a high defense IP to divert the attack traffic to the high defense IP to ensure the stable and reliable of the source station. The user purchases a high defense IP and resolves the domain name to the high defense IP. At the same time, a forwarding rule is set on the high defense. All public network traffic may be through the high defense machine room. The port protocol is forwarded to forward the user's access to the source station IP through the high defense IP, at the same time the malicious attack traffic is cleaned and filtered on the high defense IP to return the normal traffic to the source station IP, thus ensuring protection service for stable access to the source station IP.

The backend server 104 is a server attacked by DDoS, and the IP of the backend server 104 is EIP.

The server 101 may be a server that provides various services. The server 101 may modify the contents of the DNS. When the EIP enables a black hole, the server 101 modifies the IP corresponding to the high defense domain name in the DNS to a high defense IP. When the EIP closes the black hole, the server 101 modifies the IP corresponding to the high defense domain name in the DNS to the EIP. The server 101 may modify the domain name of the access request whose received destination is the backend server to the high defense domain name. If the EIP enables a black hole, the server 101 may send an access request to a cleaning device corresponding to the high defense IP, and the access request is filtered by the cleaning device and then returned to the backend server. If the EIP closes the black hole, the server 101 sends the access request directly to the backend server.

It should be noted that the server may be hardware or software. When the server is hardware, the server may be implemented as a distributed server cluster composed of a plurality of servers, or maybe implemented as a single server. When the server is software, the server may be implemented as a plurality of programs or software modules (for example, a plurality of programs or software modules for providing distributed services), or as a single software or software module, which is not specifically limited herein.

It should be noted that the method for processing data provided by the embodiments of the present disclosure is generally performed by the server 101. Accordingly, the apparatus for processing data is generally provided in the server 101.

It should be understood that the number of servers, DNS, cleaning devices and backend servers in FIG. 1 is merely illustrative. Depending on the implementation needs, there may be any number of servers, DNS, cleaning devices and backend servers.

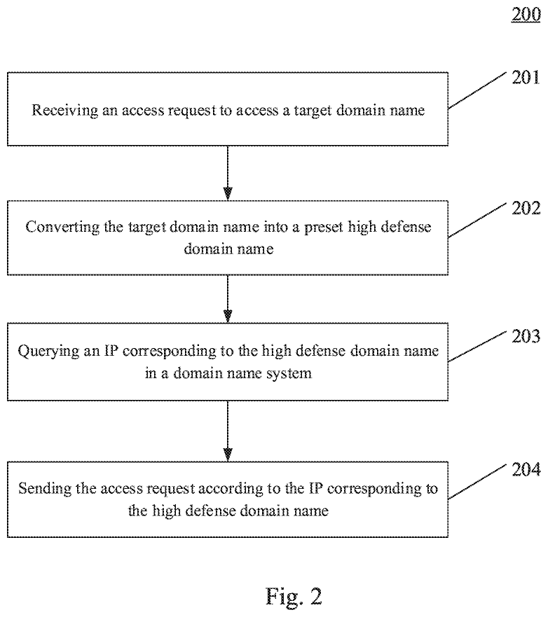

With further reference to FIG. 2, a flow 200 of a method for processing data according to an embodiment of the present disclosure is illustrated. The method for processing data includes the following steps.

Step 201, receiving an access request to access a target domain name.

In the present embodiment, an executing body (for example, the server shown in FIG. 1) of the method for processing data may receive an access request for accessing a server corresponding to the target domain name from the network through a wired or a wireless connection. The target domain name is indicated in the access request. The target domain name corresponds to the EIP in the DNS.

Step 202, converting the target domain name into a preset high defense domain name.

In the present embodiment, the target domain name in the access request is converted into a preset high defense domain name. The high defense domain name is the domain name of the cleaning device. The high defense domain name may correspond to the EIP in the DNS. The high defense domain name may alternatively correspond to a high defense IP. When the EIP enables a black hole, the server modifies the IP corresponding to the high defense domain name in the DNS to the high defense IP. When the EIP closes the black hole, the server modifies the IP corresponding to the high defense domain name in the DNS to the EIP. The black hole here may be a machine room black hole or an operator black hole. When a large traffic attack occurs, a defense system against the DDoS calls the operator black hole and discards the traffic at the operator side, which may greatly alleviate the pressure of the DDoS attack on the bandwidth of the machine room.

Step 203, querying an IP corresponding to the high defense domain name in a domain name system.

In the present embodiment, if the EIP corresponding to the target domain name enables the black hole, the IP corresponding to the high defense domain name in the domain name system is the preset high defense IP. Otherwise, the IP corresponding to the high defense domain name in the domain name system is the EIP of the target domain name.

Step 204, sending the access request according to the IP corresponding to the high defense domain name.

In the present embodiment, if the EIP enables the black hole, the server may send the access request to the cleaning device corresponding to the high defense IP. The access request is filtered by the cleaning device and then returned to the backend server. If the EIP closes the black hole, the server sends the access request directly to the backend server.

In some alternative implementations of the present embodiment, some configuration is required before performing steps 201-203, and the configuration includes the following.

1) creating a scheduling instance and a high defense domain name may be generated. The high defense domain name may be selected from a list of high defense domain names provided by a high defense service provider. The high defense domain name may alternatively be generated by user custom.

2) configuring the scheduling instance, the EIP to be scheduled, an area to which the EIP belongs, and health checking a port based on a Transmission Control Protocol (TCP) service (used in the scheduling phase to check the smooth flow in the network of a high defense machine back to the backend server). After the scheduling instance is configured, a record that the high defense domain name resolves to the EIP is created in the DNS.

3) creating a CNAME record in the DNS that the target domain name is resolved to the high defense domain name.

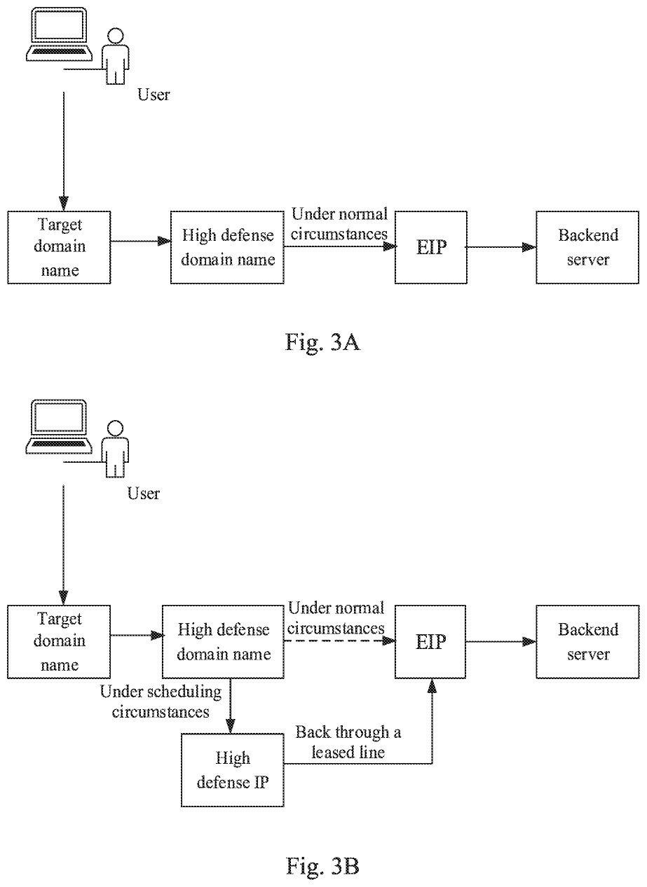

With further reference to FIG. 3A, and FIG. 3B, which are schematic diagrams of application scenarios of the method for processing data according to some present embodiments. As shown in FIG. 3A, when the black hole is not enabled in the EIP, the IP corresponding to the high defense domain name in the DNS is the EIP of the target domain name. When the server receives an access request for the target domain name, the target domain name is converted to a high defense domain name. Then, the IP corresponding to the high defense domain name (i.e., the EIP) is acquired from the DNS, and then the access request is sent to the backend server corresponding to the EIP. As shown in FIG. 3B, when the black hole is enabled in the EIP, the IP corresponding to the high defense domain name in the DNS is a high defense IP. When the server receives an access request for the target domain name, the target domain name is converted to a high defense domain name. Then, the IP corresponding to the high defense domain name (i.e., the high defense IP) is acquired from the DNS, and then the access request is sent to the cleaning device corresponding to the high defense IP. After the access request is cleaned, the cleaned access request is returned to the backend server corresponding to the EIP through a leased line.

The method provided by the above embodiments of the present disclosure has the following advantages.

1. The user does not have to bear high costs for a high defense IP, but only needs to pay a contract fee for the solution. Since the high defense IP is only used when DDOS attacks, the high defense IP may be shared with other attacked servers at other times. The use efficiency of the high defense IP is greatly improved, and the usage cost may be shared by multiple users.

2. The cumbersome user configuration in the console is avoided. The user does not need to manually purchase a high defense IP for each EIP in the console and configure a series of port forwarding rules.

3. The solution guarantees the best experience of user service. Under normal circumstances, accessing to the backend server is directly via the EIP. When the EIP is under attack and a black hole is triggered, accessing the backend server is achieved through the high defense IP and back to the EIP, ensuring the availability of the service.

4. The high defense IP may be used as needed. It eliminates the limit on the number of high defense IPs purchased by the user, and the same user may configure automated scheduling services for a large number of EIPs.

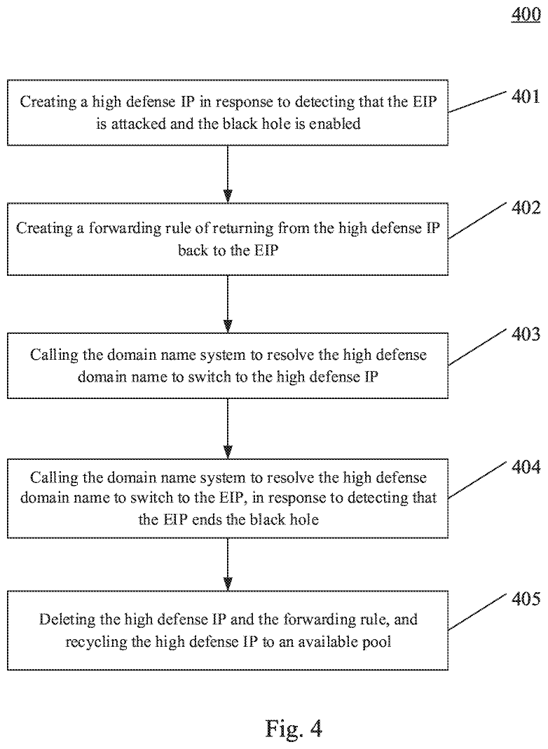

With further reference to FIG. 4, a flow 400 of the method for processing data according to another embodiment of the present disclosure is illustrated. The flow 400 of the method for processing data includes the following steps.

Step 401, creating a high defense IP in response to detecting that the EIP is attacked and the black hole is enabled.

In the present embodiment, the server may receive a message of enabling a black hole sent by the backend server, and then the server creates a high defense IP. The high defense IP may be a high defense IP purchased from a service provider.

Step 402, creating a forwarding rule of returning from the high defense IP back to the EIP.

In the present embodiment, a corresponding relationship between ports from the high defense IP back to an EIP for forwarding is configured. For example, a high defense IP port 80 corresponds to an EIP port 80. The data received by the high defense IP of the port 80 is forwarded to the port 80 on the EIP.

Step 403, calling the domain name system to resolve the high defense domain name to switch to the high defense IP.

In the present embodiment, the IP corresponding to the high defense domain name in the DNS is modified, and the original corresponding EIP is modified to be a high defense IP. In this way, after the black hole is enabled in the EIP, after the DNS resolution, when accessing the target domain name, in fact, the high defense IP is accessed. The requested traffic first arrives at the high defense machine room, then returns to the user EIP through the leased line, and finally reaches the backend server.

Step 404, calling the domain name system to resolve the high defense domain name to switch to the EIP, in response to detecting that the EIP ends the black hole.

In the present embodiment, when the EIP black hole ends, first, the DNS is called, and the high defense domain name is resolved to switch to the EIP. In this way, after the DNS resolution, when accessing the target domain name, the EIP is directly accessed, and the requested traffic directly reaches the cloud room.

Step 405, deleting the high defense IP and the forwarding rule, and recycling the high defense IP to an available pool.

In the present embodiment, after a few minutes after switching the IP of the high defense domain name in the DNS to the EIP, the high defense IP is deleted, the forwarding rule is deleted, and the high defense IP is recycled to the available pool.

As can be seen from FIG. 4, the flow 400 of the method for processing data in the present embodiment embodies the step of scheduling the DNS as compared to the embodiment corresponding to FIG. 2. Therefore, the solution described in the present embodiment may dynamically adjust the IP corresponding to the target domain name, thereby implementing free switching between the EIP and the high defense IP.

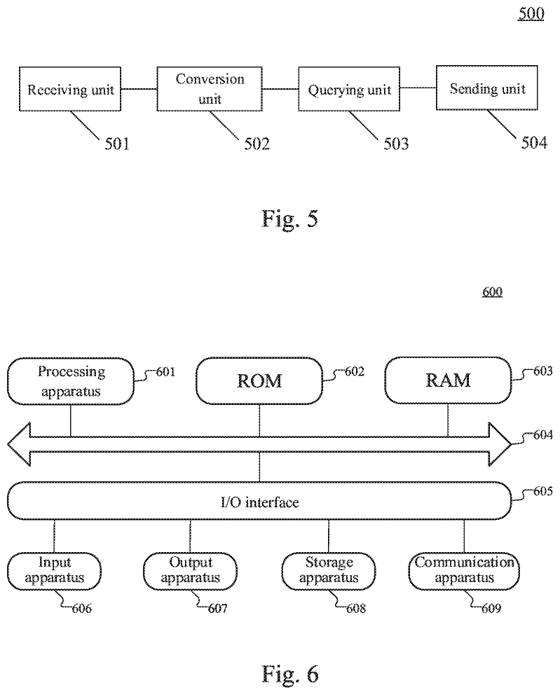

With further reference to FIG. 5, as an implementation of the method shown in the above figures, an embodiment of the present disclosure provides an apparatus for processing data, and the apparatus embodiment corresponds to the method embodiment as shown in FIG. 2, and the apparatus may be specifically applied to various electronic devices.

As shown in FIG. 5, an apparatus 500 for processing data of the present embodiment includes: a receiving unit 501, a conversion unit 502, a querying unit 503 and a sending unit 504. Here, the receiving unit 501 is configured to receive an access request to access a target domain name. The conversion unit 502 is configured to convert the target domain name into a preset high defense domain name. The querying unit 503 is configured to query an IP corresponding to the high defense domain name in a domain name system. The sending unit 504 is configured to send the access request according to the IP corresponding to the high defense domain name. In a case that an EIP corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

In the present embodiment, the specific processing of the receiving unit 501, the conversion unit 502, the querying unit 503, and the sending unit 504 of the apparatus 500 for processing data may refer to step 201, step 202, step 203 and step 204 in the corresponding embodiment of FIG. 2.

In some alternative implementations of the present embodiment, the apparatus 500 further includes a configuring unit (not shown in the figure), configured to: generate a high defense domain name before converting the target domain name into a preset high defense domain name; configure the EIP corresponding to the target domain name, an area to which the EIP belongs, and health check a port based on a TCP service;

create a record that the high defense domain name resolves to the EIP; and create a record that the target domain name resolves to the high defense domain name.

In some alternative implementations of the present embodiment, the apparatus 500 further includes a scheduling unit (not shown in the figure), configured to: create a high defense IP in response to detecting that the EIP is attacked and the black hole is enabled; create a forwarding rule of returning from the high defense IP back to the EIP; and call the domain name system to resolve the high defense domain name to switch to the high defense IP.

In some alternative implementations of the present embodiment, the scheduling unit is further configured to: call the domain name system to resolve the high defense domain name to switch to the EIP, in response to detecting that the EIP ends the black hole.

In some alternative implementations of the present embodiment, the scheduling unit is further configured to: delete the high defense IP and the forwarding rule; and recycle the high defense IP to an available pool.

With further reference to FIG. 6, a schematic structural diagram of an electronic device (for example, the server in FIG. 1) 600 adapted to implement the embodiments of the present disclosure is shown. The electronic device shown in FIG. 6 is merely an example, and should not impose any limitation on the function and scope of use of the embodiments of the present disclosure.

As shown in FIG. 6, the electronic device 600 may include a processing apparatus (e.g., central processing unit, graphics processor, etc.) 601, which may execute various appropriate actions and processes in accordance with a program stored in a read-only memory (ROM) 602 or a program loaded into a random access memory (RAM) 603 from a storage apparatus 608.

The RAM 603 also stores various programs and data required by operations of the electronic device 600. The processing apparatus 601, the ROM 602 and the RAM 603 are connected to each other through a bus 604. An input/output (I/O) interface 605 is also connected to the bus 604.

Typically, the following apparatuses may be connected to the I/O interface 605: an input apparatus 606 including a touch screen, touch pad, keyboard, mouse, camera, microphone, accelerometer, gyroscope and the like; an output apparatus 607 including a liquid crystal display (LCD), a speaker, a vibrator and the like; a storage apparatus 608 including a magnetic tape, a hard disk and the like; and a communication apparatus 609. The communication apparatus 609 may allow the electronic device 600 to communicate in a wired or wireless connection with other devices to exchange data. Although FIG. 6 illustrates the electronic device 600 having various apparatuses, it should be understood that it is not required to implement or have all of the illustrated apparatuses. More or less apparatuses may be alternatively implemented or possessed. Each block shown in FIG. 6 may represent one apparatus or may represent a plurality of apparatuses as desired.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 609, or may be installed from the storage apparatus 608 or from the ROM 602. The computer program, when executed by the processing apparatus 601, implements the above mentioned functionalities as defined by the method of the embodiments of the present disclosure. It should be noted that the computer readable medium described by the embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the embodiments of the present disclosure, the computer readable storage medium may be any physical medium containing or storing programs which may be used by a command execution system, apparatus or element or incorporated thereto. While in the embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable signal medium is capable of transmitting, propagating or transferring programs for use by, or used in combination with, a command execution system, apparatus or element. The program codes contained on the computer readable medium may be transmitted with any suitable medium including but not limited to: wired, optical cable, RF medium etc., or any suitable combination of the above.

The computer readable medium may be included in the above electronic device, or a stand-alone computer readable medium not assembled into the electronic device. The computer readable medium stores one or more programs. The one or more programs, when executed by the electronic device, cause the electronic device to: receive an access request to access a target domain name; convert the target domain name into a preset high defense domain name; query an IP corresponding to the high defense domain name in a domain name system; and send the access request according to the IP corresponding to the high defense domain name; where in a case that an EIP corresponding to the target domain name enables a black hole, the IP corresponding to the high defense domain name in the domain name system is a preset high defense IP, and in a case that the EIP corresponding to the target domain name closes a black hole, the IP corresponding to the high defense domain name in the domain name system is the EIP of the target domain name.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flowcharts as well as a combination of blocks maybe implemented using a dedicated hardware-based system executing specified functions or operations, or by a combination of a dedicated hardware and computer instructions.

The units involved in the embodiments of the present disclosure maybe implemented by means of software or hardware. The described units may also be provided in a processor, for example, described as: a processor, including a receiving unit, a conversion unit, a querying unit, and a sending unit. Here, the names of these units do not in some cases constitute a limitation to such units themselves. For example, the receiving unit may also be described as “a unit configured to receive an access request to access a target domain name.”

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for processing data, the method comprising:
receiving an access request to access a target domain name;
converting the target domain name into a preset high defense domain name;
querying an IP corresponding to the high defense domain name in a domain name system; and
sending the access request according to the IP corresponding to the high defense domain name;
wherein, in a case that an Elastic IP (EIP) corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

2. The method according to claim 1, wherein, before converting the target domain name into a preset high defense domain name, the method further comprises:
generating a high defense domain name;
configuring the EIP corresponding to the target domain name, an area to which the EIP belongs, and health checking a port based on a Transmission Control Protocol (TCP) service;
creating a record that the high defense domain name resolves to the EIP; and
creating a record that the target domain name resolves to the high defense domain name.

3. The method according to claim 2, wherein the method further comprises:
creating a high defense IP in response to detecting that the EIP is attacked and the black hole is enabled;
creating a forwarding rule of returning from the high defense IP back to the EIP; and
calling the domain name system to resolve the high defense domain name to switch to the high defense IP.

4. The method according to claim 3, wherein the method further comprises:
calling the domain name system to resolve the high defense domain name to switch to the EIP, in response to detecting that the EIP ends the black hole.

5. The method according to claim 4, wherein the method further comprises:
deleting the high defense IP and the forwarding rule; and
recycling the high defense IP to an available pool.

6. An apparatus for processing data, the apparatus comprising:
at least one processor; and
a memory storing instructions, wherein the instructions when executed by the at least one processor, cause the at least one processor to perform operations, the operations comprising:
receiving an access request to access a target domain name;
converting the target domain name into a preset high defense domain name;
querying an IP corresponding to the high defense domain name in a domain name system; and
sending the access request according to the IP corresponding to the high defense domain name;
wherein, in a case that an EIP corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

7. The apparatus according to claim 6, wherein, before converting the target domain name into a preset high defense domain name, the operations further comprise:
generating a high defense domain name before converting the target domain name into a preset high defense domain name;
configuring the EIP corresponding to the target domain name, an area to which the EIP belongs, and health checking a port based on a Transmission Control Protocol (TCP) service;
creating a record that the high defense domain name resolves to the EIP; and
creating a record that the target domain name resolves to the high defense domain name.

8. The apparatus according to claim 7, wherein the operations further comprise:
creating a high defense IP in response to detecting that the EIP is attacked and the black hole is enabled;
creating a forwarding rule of returning from the high defense IP back to the EIP; and
calling the domain name system to resolve the high defense domain name to switch to the high defense IP.

9. The apparatus according to claim 8, wherein the operations further comprise:
calling the domain name system to resolve the high defense domain name to switch to the EIP, in response to detecting that the EIP ends the black hole.

10. The apparatus according to claim 9, wherein the operations further comprise:
deleting the high defense IP and the forwarding rule; and
recycling the high defense IP to an available pool.

11. A non-transitory computer readable medium, storing a computer program thereon, the program, when executed by a processor, causes the processor to perform operations, the operations comprising:
receiving an access request to access a target domain name;
converting the target domain name into a preset high defense domain name;
querying an IP corresponding to the high defense domain name in a domain name system; and
sending the access request according to the IP corresponding to the high defense domain name;
wherein, in a case that an EIP corresponding to the target domain name enables a black hole, the IP corresponding to the high defense domain name in the domain name system is a preset high defense IP, and in a case that the EIP corresponding to the target domain name closes the black hole, the IP corresponding to the high defense domain name in the domain name system is the EIP of the target domain name.

12. The non-transitory computer readable medium according to claim 11, before converting the target domain name into a preset high defense domain name, the operations further comprise:
generating a high defense domain name before converting the target domain name into a preset high defense domain name;
configuring the EIP corresponding to the target domain name, an area to which the EIP belongs, and health checking a port based on a Transmission Control Protocol (TCP) service;
creating a record that the high defense domain name resolves to the EIP; and
creating a record that the target domain name resolves to the high defense domain name.

13. The non-transitory computer readable medium according to claim 12, wherein the operations further comprise:
creating a high defense IP in response to detecting that the EIP is attacked and the black hole is enabled;
creating a forwarding rule of returning from the high defense IP back to the EIP; and
calling the domain name system to resolve the high defense domain name to switch to the high defense IP.

14. The non-transitory computer readable medium according to claim 13, herein the operations further comprise:
calling the domain name system to resolve the high defense domain name to switch to the EIP, in response to detecting that the EIP ends the black hole.

15. The non-transitory computer readable medium according to claim 14, wherein the operations further comprise:
deleting the high defense IP and the forwarding rule; and
recycling the high defense IP to an available pool.
